(19) United States
(12) Patent Application Publication
(10) Pub. No.: US 2003/0065652 A1
(43) Pub. Date: Apr. 3, 2003

(54) Method and apparatus for indexing and searching data

(76) Inventor: Simon Alan Spacey, London (GB)

Correspondence Address: SIMON ALAN SPACEY, SUITE 94, 2 LANSDOWNE ROW, LONDON, WIJ GHL, GB

(21) Appl. No.: 10/098,494

(22) Filed: Mar. 18, 2002

(30) Foreign Application Priority Data
Sep. 10, 2001 (GB) 0121849.4

(51) Int. Cl. G06F 7/00

(52) U.S. Cl. 707/3

(57) ABSTRACT

This invention presents a method or system for rapidly indexing and searching data. The method can be used to quickly return all locations with a data set where a group of bytes is to be found. The invention works by creating a special index on the data structure. The index can be synchronised with the data source as inserts and deletions are performed so that there is no need to rebuild the index. The method according to the invention performs with a similar speed to a traditional optimised search tree but has at most the same number of elements as the data it indexes making the method of the invention ideal for indexing and searching large quantities of dynamic or static data.

### BACKGROUND OF THE INVENTION

Searching and indexing data is a critical part of every industry. However, with more and more information held on computers and on the web, the need for an efficient way to search through electronic information has never been more apparent.

Previously, search methods have been either optimised for static or dynamic data. The first type typically created an optimised search tree on the data that indexed every occurrence of every combination of symbols in a tree. Search trees are however slow to create and altering them as data is added and deleted at random locations is non-trivial. The major issue with search trees is that their size grows almost exponentially with the data they index meaning that it is impractical to use them to index large quantities of data (hence the need for blocks in LZ77 implementations).

Dynamic data on the other hand is often not indexed at all and searches take the form of a linear search from the start to the end of the data string. The search process is generally slower than using a search tree, especially if the same data is being searched many times, but this approach has the advantage of not having to create and maintain an index.

The present invention seeks provide a way to index and search any type of data with all the speed benefits of an optimised search tree but without the disadvantages of a search trees in terms of creation time, complexity, maintenance and memory requirements. The invention as presented can be easily implemented in dedicated hardware or software as part of a computer system if required.

### BRIEF SUMMARY OF THE INVENTION

It is an object of the present invention to provide a method for efficiently indexing and searching data. The method is flexible enough to work with data of any length and of any type (including bytes, 7-bit ASCII and 16-bit UNICODE) and the index can easily be manipulated as information is inserted and deleted at random locations within the corresponding data.

There are then 3 aspects to the invention that will be considered in turn: the index structure itself, manipulating the index and searching the index. In considering these aspects the word “symbols” is defined as the set of unitary patterns on which the data string can be searched. For byte data then there are generally 256 symbols, for 7-bit ASCII there are generally 128 and for 16-bit UNICODE there are up to 65,536 possible symbols.

The index consists of a number of lists. There is one list for each symbol in the data set. Each list is used to hold the positions where a particular symbol is to be found in the corresponding data string. Reading each symbol from the data string in turn and adding its position to the list of the corresponding symbol in the index initialises the index.

The index can be kept up-to-date as data is inserted in the data string by:

1. Searching through each list in the index and increasing all positions that reference symbols at or after the insertion point by the length of the data inserted. This has the effect of shifting the reference positions of those indices effected by the insert forward.

2. Reading each symbol from the inserted data in turn and adding a reference to its position to the index list for the corresponding symbol. The position references used will be biased by the insertion point so that the new index elements correctly reference positions in the inserted data portion of the new data string.

Where a portion of the data is dropped or removed from the data string the index can be updated by:

1. Searching through each list in the index for elements that reference positions either at or after the deletion point.

2. If the position is in the deletion range (between the deletion point and deletion point+length−1) then the element is deleted from the index list.

3. If the position is after the deletion range (>=deletion point+length) then that element's reference is decreased by the length of the deletion. This has the effect of shifting the reference positions of those indices after the deletion range backwards.

The above method can be enhanced where the entire data string is cleared by simply dropping the index and creating a new blank one and resetting any internal variables.

The index is searched for a find string by:

1. Copying the positions in the index list corresponding to the first symbol in the find string to a working list

2. Initialising a current find symbol pointer to the second symbol in the find string if there is one otherwise going straight to step 8

3. Initialising a current list element pointer to the first element in the working list

4. Searching through the index list corresponding to the current find symbol for a position reference equal to the offset of that symbol in the find string plus the position reference of the current list element in the working list

5. If no match is found, the current list element is deleted from the working list

6. The current list element pointer is incremented and steps 4-5 repeated for all elements in the working list

7. The current find symbol pointer is moved to the next symbol in the find string and steps 3-6 are repeated until all the elements in the find string have been validated

8. The working list now contains a validated list of all positions in the data string where the find string starts. This list may be sorted if required and returned in any format (perhaps only the first match position would be returned as an integer).

In a method according to the invention, a list of positions is held for each symbol in the data. It is to be noted that the symbols of interest for indexing are those that will be searched on later and that this is not necessarily the source symbols of the data set. For example, if only searches on whole words were required on an ASCII text, then the symbol set selected for indexing may be entire textual words and not the individual 128 ASCII source symbols. Further, there is strictly only a need to have a list in the index for active symbols found in the data string. This may mean that the number of lists is dynamic and grows as more symbols are actually used and indexed in a particular data string.

In a second method of the invention, position references are updated to keep the index up-to-date as the data string is altered by insertion or deletion. It is recognised that this update process may be optimised by applying the update only to lists corresponding to the symbols effected by the insertion or deletion so narrowing down the number of lists that have to be searched through. This particularly applies to insertions at the very end of the data string (appending data). Here, stage 1 of the insertion process as presented would not be required.

In the preferred embodiment of the invention the search process is optimised in 3 ways:

1. Caching results. A number of past result lists are cached along with their find string to prevent the need for re-searching the index. Elements of this cache may be wiped when the index is altered as part of the insertion and removal process.

2. Pre-processing the working list produced in stage 1 before continuing to stage 2 of the search process. This pre-processing can include: the removal any list elements from the working list that have position references to close to the end of the data to be able to match the find string completely (position>data string length−find length); and the removal of all list elements before a parameterised find start position to allow for finds from a start position forward.

3. Post-processing the working list before it is returned at stage 8. This can include sorting the working list in position order, transforming the list into another form (perhaps a results array) or returning a subset of the list (perhaps between a start and end position or the first occurrence of the find string only).

In another embodiment of the system according to the invention, the index is locked while deleting, inserting and optionally searching to allow the index to be accessed by more than one thread.

In another embodiment of the system according to the invention, each position list is kept sorted on insertion so that there is no need to post-process the working list before it is returned.

In a further embodiment of the system according to the invention, the list is not copied at stage 1 of the search process. Instead a list of references is constructed pointing to each element in the first find symbols position list and this reference list removed from as the find process continues.

In yet another embodiment of the system according to the invention, the search process is performed in reverse order by constructing a first working list of positions based on the last symbol in the find string and working backwards through the find symbols to validate it.

### BRIEF DESCRIPTION OF THE DRAWINGS

Embodiments of the invention will now be disclosed, for example purposes only and without limitation, with reference to the accompanying drawings, in which:

FIG. 1 shows a pictorial representation of the search index.

FIG. 2 shows an interface to the list elements.

FIG. 3 shows the process for indexing data inserted into a data string.

FIG. 4 shows the process of searching the index.

### DETAILED DESCRIPTION

A preferred embodiment of the invention will now be disclosed, without the intention of a limitation, in a computer software system for the purpose of searching a byte data string. The invention will be disclosed with the aid of an example showing how a particular byte data string is indexed and searched.

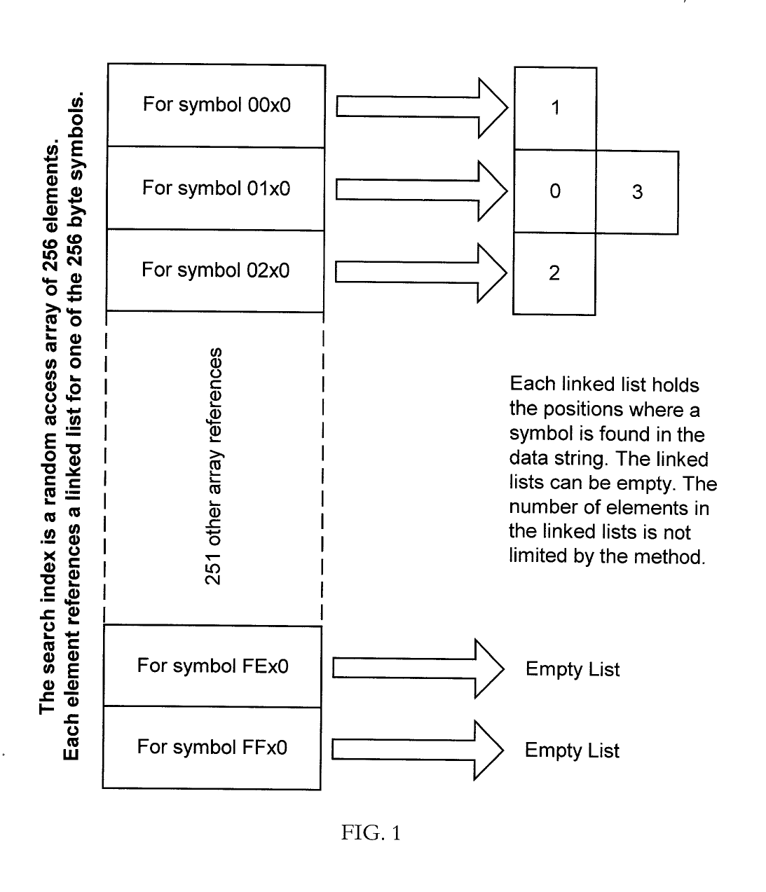

In this, the preferred embodiment, the symbol set selected for indexing is every byte from 00x0 to FFx0 (in hex) to allow the index to be searched on find strings of one or more bytes. A static index is used with 256 lists in total. A reference to the first element of each of these lists is held in a random access array with 256 array locations. The index array is constructed so that the list referenced by an array position YZx0 holds the positions where byte symbol YZx0 is found in the data string. A representation of this index structure is shown in FIG. 1. The representation as shown is consistent with the later example in this section used for demonstrating the search process.

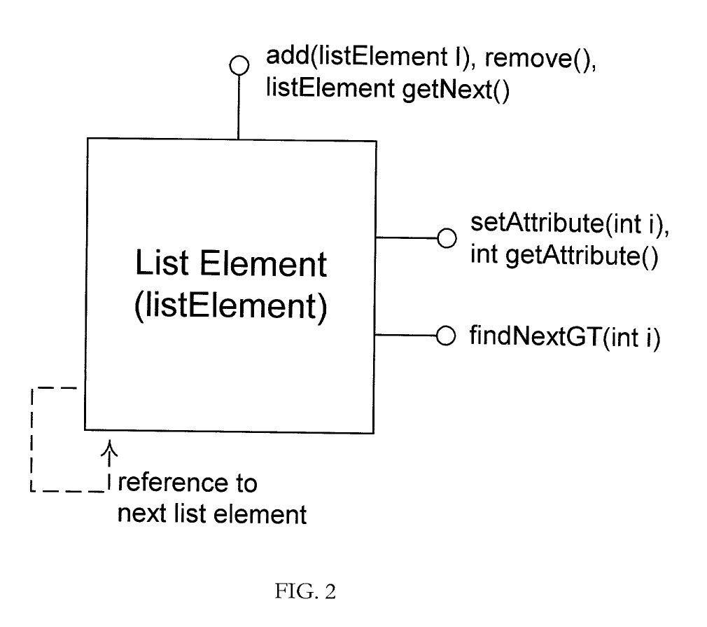

The lists used in this embodiment are singly linked lists (forward only) with only a single attribute—that of a long integer. The integer attribute of the list elements will hold the position where a byte of the corresponding symbol occurs in the data string (zero biased). The lists will have an extra method to search the list chain forward from the current element to find and return the next element with an attribute value greater than a passed parameter. This is an optimisation over a standard linked list and helps in the insertion, deletion and search processes and is shown in FIG. 2 as the getNextGT(int i) function. This function could quite easily be replaced by a similar getNextGE(int i) function to find the next element greater than or equal to the parameter if required in a future implementation.

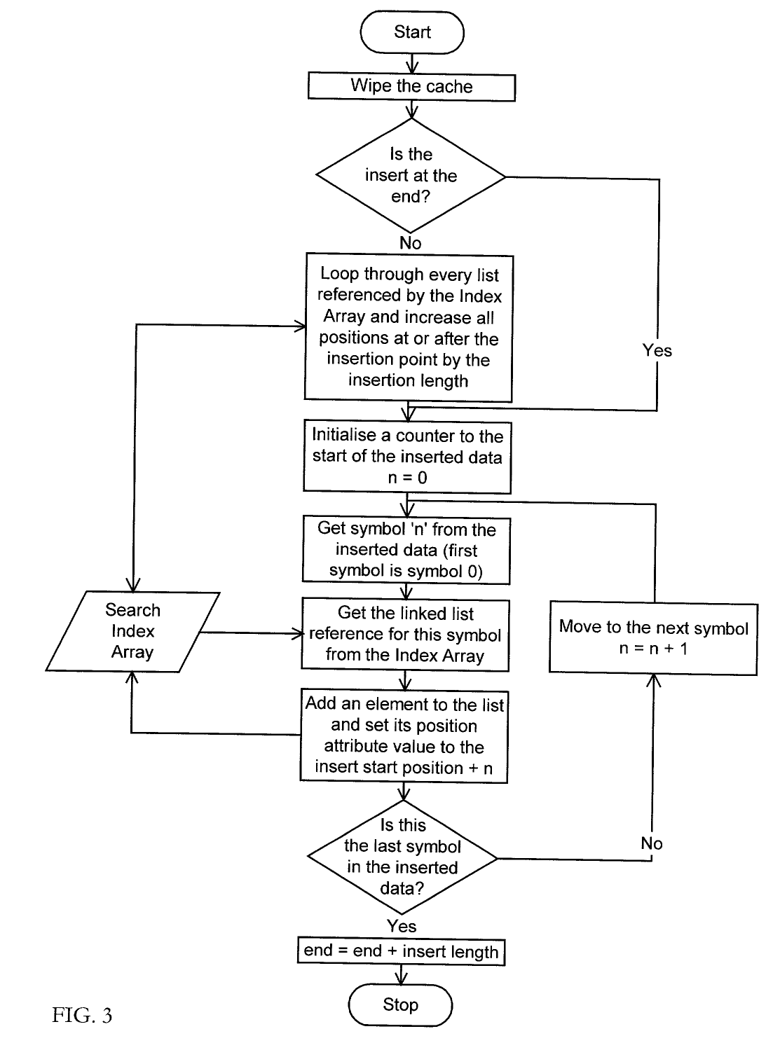

FIG. 3 shows the general process for indexing byte data with this embodiment. In this embodiment the process of initialising the index against a data string is implemented using the same method as the insertion process illustrated in FIG. 3 with the exception that the insertion point is at the end of the data string (initially at point 0).

To elaborate further the process of initially indexing a data string, an example will now be disclosed without the intention of limitation. In this example, the data string to be indexed consists of the 3 bytes: 00x1, 02x0 and 01x1. The index is created in accordance with the invention thus:

1. An fresh blank index structure is created with initial end position 0 and a blank cache

2. The data string is sent to the index for insertion at position 0 (the end)

3. Since the insert position is at the end of the current index, no list positions need be shifted and the shift stage is not performed

4. The first byte is read from the data string. It is 01x0 and occurs at position 0. Thus an element is added to the 01x0 list referenced by the corresponding index array element number 01x0 (the second array element given a zero bias). The added list element has its position attribute set to 0.

5. The second byte is read from the data string. It is 02x0 and occurs at position 1 in the data string (zero biased). An element is added to the 02x0 list referenced by array position 02x0 in the index array (the third list). The added list element has its position attribute set to 1 (02x0 occurs at position 1).

6. The third byte is read from the data string. It is 01x0 and occurs at position 2 in the data string (zero biased). An additional element is now added to the 01x0 list referenced by array element 01x0 in the index. The added list element has its position attribute set to 2.

7. The index end position is updated to 3 by adding the number of bytes inserted and the process is complete

The first 3 lists in the index can now be represented as:

00x0: List Empty

01x0: {0}, {2}

02x0: {1}

The process of inserting 2 bytes of 00x0 and 02x0 into the data string at position 1 (at the second byte) would be:

1. The insertion bytes {00x0, 02x0} are sent to the index for insertion at position 1

2. The cache is wiped

3. Since the insert position is not after the end of the current index (i.e. not at position 3), some of the list positions will need to be shifted and each of the 256 lists in the index is searched through and any elements with positions greater than 0 (equivalent to saying any elements with positions greater than or equal to the insertion point) are shifted by adding 2 to them (the length of the insert). After this stage, the first 3 elements of the index look like this:

00x0: List Empty

01x0: {0}, {4}

02x0: {3}

4. The 00x0 byte is read from the insert string and an element is added to the 00x0 list referenced by array element 00x0 in the index. The added list element has its position attribute set to 1 (the insertion position+0). The first 3 elements of the index now look like:

00x0: {1}

01x0: {0}, {4}

02x0: {3}

5. The 02x0 byte is read from the insert string and an element is added to the 02x0 list referenced by array element 02x0 in the index. The added list element has its position attribute set to 2 (the insertion position+1). The first 3 elements of the index now look like:

00x0: {1}

01x0: {0}, {4}

02x0: {3}, {2}

6. The index end position is updated by adding the length of data inserted (2) and is now 5. The process is complete

As a quick check, the data string can easily be recovered from the index. This is achieved by:

1. Searching through each list until you find the list with an element with position attribute of 0. Then placing the symbol corresponding to this list on the output stream.

2. Finding the list with an element with a position attribute value of 1 and place the symbol corresponding to that list on the output stream.

3. Continue by finding the next positions (2, 3, 4 . . . ) in the lists and outputting the symbol corresponding to the list where each position was found to the output stream in turn until the end position and all the data string has been recovered.

Performing this index recovery technique on the example index at this stage reveals the data string: 01x0, 00x0, 02x0, 02x0, 01x0 as expected.

For the purpose of examining the deletion process we will now show how to update the index when the second 02x0 byte is deleted from the data string. This is equivalent to deleting from position 3 with length 1:

1. The cache is wiped

2. Each index list is searched for positions greater than or equal to the deletion point.

3. List 01x0 has one element with a position greater than 2. This is its second list element and it has an attribute value of 4. As this element is after the data being deleted, it is shifted back by 1 (the deletion length) and the element's attribute value set to 3.

4. List 02x0 has one element with a position greater than 2. This is the first list element in the unsorted list which has an attribute value of 3. Since this attribute value is in the range of deletion (the range 3 to 3 as only one byte is deleted here), this element is removed from the 02x0 list.

5. No other lists or elements are effected, the index end position is reduced by 1 (the number of bytes removed) to 4 and the process is ended with index state:

00x0: {1}

01x0: {0}, {3}

02x0: {2}

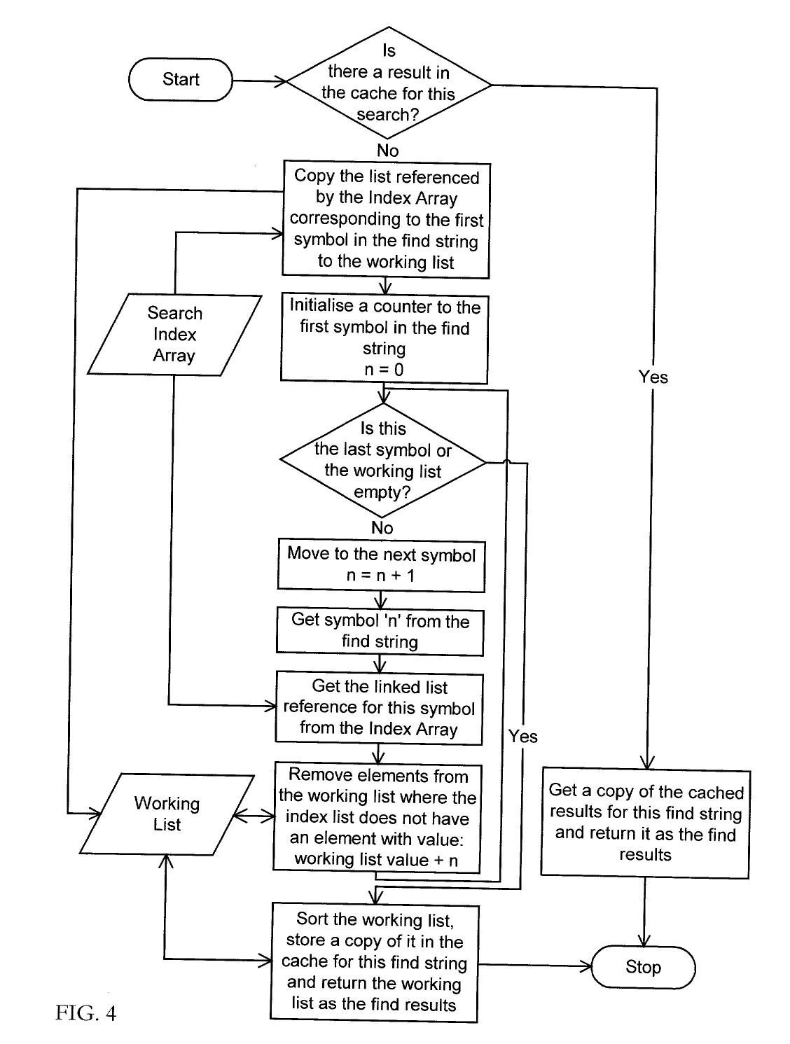

FIG. 4 shows the general process of searching through the index of the preferred embodiment. Continuing with the example, searching for the 2 byte find string: 01x0, 00x0 would return one result at position 0 as illustrated below:

1. The cache is searched with the find string and, since it is empty, the process continues

2. A new (blank) working list is created

3. The working list is initialised by creating a new list element for each of the elements in the index's 01x0 list (corresponding to the first search byte) and setting the attribute of that new element to the same position value as in the 01x0 list. This reveals an initial working list of:

Working List: {0}, {3}

4. Next the list corresponding to the second find byte in the index is examined. This is the list referenced by position 00x0 in the index array. This list has only one element, value {1}.

5. This 00x0 index list is checked first for a value of {1} (1=0+1 i.e. first working element value +position in find string). This value is found and confirms that there is a match so far for the find string that starts at position 0 (as identified by the first element of the working list).

6. The 00x0 index list is next checked for value {4} (4=3+1 i.e. the second element in the working list). This value is not found in the 00x0 list and so the find string does not occur in the data string at position 3. The second working element is consequently removed form the working list. The working list now becomes:

Working List: {0}

7. Since there are no more bytes in the find string the search process is complete and the working list is not whittled down further. The working list is sorted, copied into the cache for future reference and returned as the find result showing that there is only one match of the find string in the data string and that match starts at position 0.

In the preferred embodiment, the index consists of an array of references to linked lists. This index form could easily be replaced by: a list of references to position lists (lists for a dynamic number of symbols referencing dynamic lists of positions) or a 2D array where each row contains a number of position references (perhaps terminated by a −1) or even a list containing references to arrays of positions.

In the preferred embodiment, the position lists can be empty. This may be implemented by holding a null reference in the index array and by instantiating new lists and creating references to these new lists when a symbol is first indexed. Alternatively, each array element may be initialised with a valid reference to a real list at start-up and either the first element of that list ignored or marked with an attribute value of −1 indicating that it is empty. The former of these two approached may be preferred as it allows simpler insertion and deletion routines.

In the preferred embodiment, positions for insert, delete and search are inclusive and start at 0 for the first character in the data string. It is recognised that this is implementation dependant and positions could equally well be exclusive using say, −1 for inserts at the beginning of the data. It is also recognised that in a commercial version of the method the insert, delete and search positions and lengths would be validated before use.

In a first embodiment, inserts and deletes in the index use start and length parameter references however this approach can easily be adapted to use other parameter references such as start and end positions.

As an alternative to indexing an entire data string, the embodiment may be used with minor modifications to index only part of a data string. This can be achieved by creating a new search index, inserting data in it from the portion of the data string and indicating the correct start position as a parameter to the insert. The index elements would then contain positions within the indexed portion only and be searched normally. It is recognised that the end position pointer may require setting to the start of the indexed portion plus the length of the insert and that any parameter checking would be slightly different.

Along with the objects, advantages and features described, those skilled in the art will appreciate other objects, advantages and features of the present invention still within the scope of the claims as defined. For instance, the full data string can be recovered easily from the index as illustrated here. This means that the index can be used as a means to store and recover data strings rather than needing both the original data string and a separate index.

We claim:

1. An index for indexing data characterised by: a number of lists, each list holding references to the positions where a particular symbol is found in the data.

2. A method in accordance with claim 1 wherein said number of lists is static and determined so that there is one active list for each symbol that can be searched on.

3. A method in accordance with claims 1 or 2 wherein said number of lists is dynamic and increases as new symbols are indexed.

4. A method according to claims 1, 2 or 3 for adding indices to the index for data inserted into a data string, characterised by:
a) Searching through each list in the index and increasing any positions that reference a point at or after the insertion point by the length of the data inserted
b) Reading each symbol from the inserted data and adding a reference to its position in the data string to the list corresponding to that symbol in the index

5. A method according to claim 4 wherein only part of a data string is indexed.

6. A method according to claims 4 or 5 wherein the lists effected by an insert are sorted after the insert.

7. A method according to claims 1, 2 or 3 for removing indices from the index for data removed from a data string, characterised by:
a) Searching through each list in the index for elements that reference positions either at or after the deletion point.
b) If the position is in the deletion range then the element is deleted from the list.
c) If the position is after the deletion range then the element's position attribute is decreased by the length of the deletion

8. A method according to claims 4, 5, 6 or 7 wherein only lists corresponding to those symbols that are in the data effected by an insert or deletion in the data string are searched through and effected.

9. A method in accordance with any of the previous claims for searching for a find string or data sequence using the index, characterised by:
a) Taking the index list corresponding to the first symbol in the find string as an initial working list of potential matches
b) Validating this working list against the positions in index lists corresponding to later symbols in the find string
c) Returning one or more of the valid working list entries

10. A method in accordance with claim 9 wherein the working list is initially created by using the index list corresponding to the last symbol in the find string instead of the first and this list is validated by checking the lists for symbols earlier than the last symbol in the find string.

11. A method in accordance with claims 9 or 10 wherein, the working list is composed of references to list elements in the index instead of copies of them

12. A method in accordance with claims 9 through 11 wherein the search is optimised by one or more of the following:
a) A cache used to store and retrieve search results
b) Pre-processing the working list
c) Post-processing the working list

13. A method in accordance with any of the previous claims wherein the index is locked while inserting, deleting and optionally searching

14. A method in accordance with any of the previous claims used for the storage and retrieval of a data string wherein the data or a part thereof is recovered from the index

15. A method in accordance with any of the previous claims with special reference to claim 1 wherein the index is one or more of:
a) An array of lists
b) A array of list references
c) A list of lists
d) A list of list references

16. A method accordant to any of the previous claims wherein the said lists are linked lists

17. A method in accordance with claims 15 and 16 wherein the linked lists are specially constructed to have a helper method that finds the next list element with a value greater than an input parameter

18. A method in accordance with any of the previous claims wherein the symbols indexed are groups of one or more of the symbols that make-up the data string and can be bytes, ASCII, UNICODE or textual words.

19. A method in accordance with any of the previous claims wherein the insert, delete and search parameters are validated before being used

20. A method substantially as herein described with reference to FIGS. 1 to 4 of the accompanying drawings

21. Use of any of the methods of claims 1 to 20.

22. Apparatus configured to perform any one of the methods of claims 1 to 20.

23. Means to perform any of the methods of claims 1 to 20.
